(19) United States
(12) Patent Application Publication
(10) Pub. No.: US 2024/0305757 A1
(43) Pub. Date: Sep. 12, 2024

(54) PROJECTION METHOD FOR PROJECTOR, PROJECTOR, NON-TRANSITORY COMPUTER-READABLE STORAGE MEDIUM STORING CONTROL PROGRAM FOR PROJECTOR

(71) Applicant: SEIKO EPSON CORPORATION, Tokyo (JP)

(72) Inventor: Jun YOSHIMURA, HIJI-MACHI (JP)

(21) Appl. No.: 18/599,512

(22) Filed: Mar. 8, 2024

(30) Foreign Application Priority Data
Mar. 8, 2023 (JP) 2023-035333

(51) Int. Cl. H04N 9/31

(52) U.S. Cl. CPC H04N 9/3185; H04N 9/3182; H04N 9/3191

(57) ABSTRACT

A projection method for a projector includes: projecting, onto a screen, a correction target image that is a target of shape correction; and projecting, onto the screen, a guide image showing a maximum range within which the correction target image can be projected, when the correction target image is projected on the screen.

The present application is based on, and claims priority from JP Application Serial Number 2023-035333, filed Mar. 8, 2023, the disclosure of which is hereby incorporated by reference herein in its entirety.

### BACKGROUND

### 1. Technical Field

The present disclosure relates to a projection method for a projector, a projector, and a non-transitory computer-readable storage medium storing a control program for a projector.

### 2. Related Art

According to the related art, a technique related to a projection method for a projector is known.

For example, JP-A-2017-195634 describes a projector configured to be able to move a corner of an input image as an adjustment point in response to an operation of a direction key and configured in such a way that a user, while viewing an input image projected on a projection surface, can move, for example, the top left corner toward the bottom right by a necessary amount and thus can correct a keystone distortion of the input image.

In the technique described in JP-A-2017-195634, image light of an input image is generated by modulating light from a light source by a light modulation device driven according to the image data of the input image. When the light modulation device is a liquid crystal panel, for example, the liquid crystal panel has a maximum number of pixels, that is, a maximum range of use. Therefore, when the input image is moved beyond the maximum range of use of the liquid crustal panel, a part of the input image is not projected on the projection surface and disappears.

As such, the user grasps that the amount of movement of the input image is limited, only when recognizing that a part of the input image has disappeared in the process of moving the input image. In other words, the user cannot recognize in advance the range within which the input image can be moved. Such a problem similarly arises even when the light modulation device is a DMD (digital micromirror device). Thus, there is room for improvement in the convenience for the user when moving the input image.

### SUMMARY

According to an aspect of the present disclosure, a projection method for a projector includes: projecting, onto a projection surface, a correction target image that is a target of shape correction; and projecting, onto the projection surface, a guide image showing a maximum range within which the correction target image can be projected, when the correction target image is projected on the projection surface.

According to another aspect of the present disclosure, a projector includes an optical device and a processor. The processor executes: projecting, onto a projection surface, a correction target image that is a target of shape correction; and projecting, onto the projection surface, a guide image showing a maximum range within which the correction target image can be projected, when the correction target image is projected on the projection surface.

According to still another aspect of the present disclosure, a non-transitory computer-readable storage medium storing a control program for a projector is provided. The control program causes a processor to execute: projecting, onto a projection surface, a correction target image that is a target of shape correction; and projecting, onto the projection surface, a guide image showing a maximum range within which the correction target image can be projected, when the correction target image is projected on the projection surface.

### BRIEF DESCRIPTION OF THE DRAWINGS

FIG. 1 shows an example of the configuration of a projector according to an embodiment.

FIG. 2 shows an example of the configuration of a first controller of the projector.

FIG. 3 shows an example of the configuration of an image projection system in an initial state.

FIG. 4 shows an example of a correction target image and a line image in a first state.

FIG. 5 shows an example of the correction target image and the line image in a second state.

FIG. 6 is a flowchart showing an example of processing by the first controller of the projector.

### DESCRIPTION OF EMBODIMENTS

An embodiment will now be described with reference to the drawings.

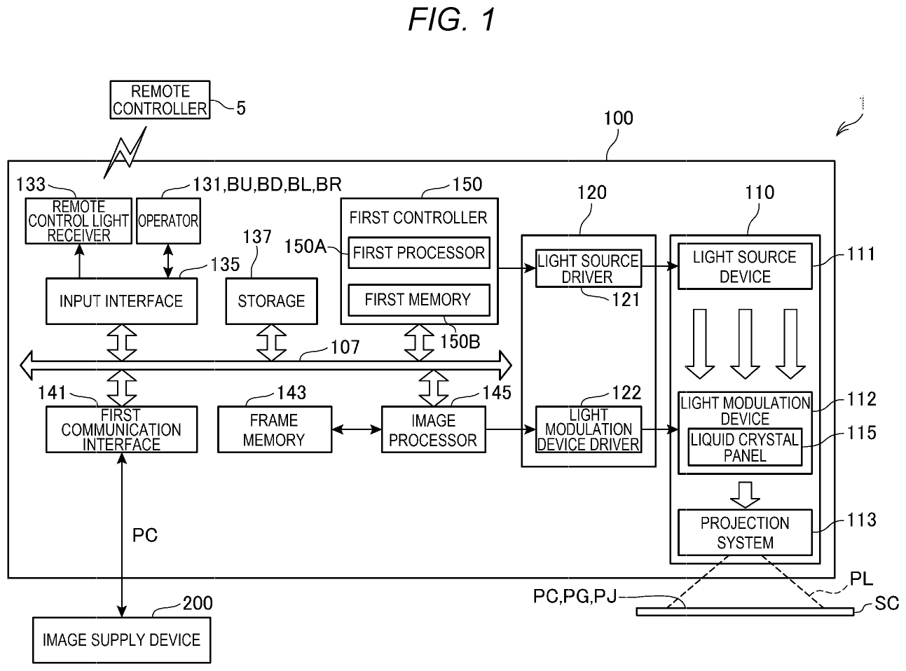

FIG. 1 shows an example of the configuration of a projector 100 according to this embodiment.

An image projection system 1 has the projector 100 and an image supply device 200.

The image supply device 200 is formed of, for example, a personal computer or the like and supplies a correction target image PC to the projector 100. The image supply device 200 transmits the correction target image PC to the projector 100, for example, via an Ethernet (registered trademark) cable. The correction target image PC is an image used by the projector 100 as a target of shape correction.

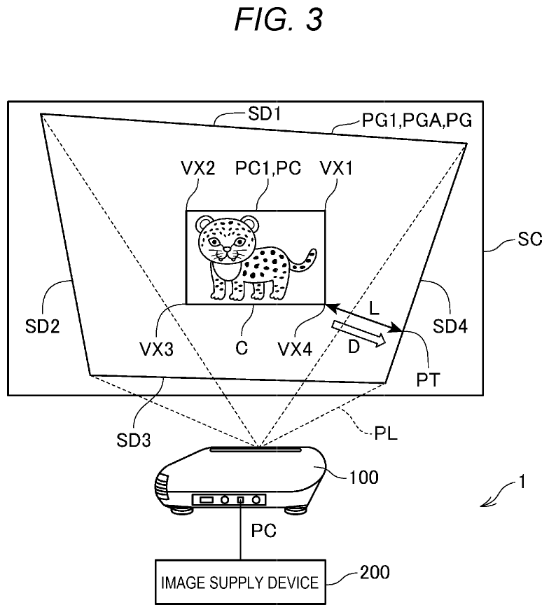

The correction target image PC will be described further with reference to FIGS. 3 to 5.

In this embodiment, the image supply device 200 is connected in such a way as to be able to perform wired communication with the projector 100 via an Ethernet (registered trademark) cable or like. However, the image supply device 200 may be connected in such a way as to be able to perform wireless communication with the projector 100 via Wi-Fi (registered trademark) or the like.

In this embodiment, the image supply device 200 is formed of a personal computer. However, the image supply device 200 may be formed of a tablet terminal, a smartphone, or the like.

The projector 100 projects image light PL in a projection area RS on a screen SC. The projector 100 also projects the image light PL in such a way as to display a projection image PJ on the screen SC. The projection image PJ includes the correction target image PC and a guide image PG.

The guide image PG shows a maximum range within which the projection image PJ such as the correction target image PC ca be projected.

The guide image PG will be described further with reference to FIGS. 3 to 5.

The configuration of the projector 100 will now be described with reference to FIG. 1.

As shown in FIG. 1, the projector 100 has a projection device 110 and a driver 120 that drives the projection device 110. The projection device 110 forms an optical image and projects the image light PL onto the screen SC. In this embodiment, the projection device 110 projects the image light PL corresponding to the projection image PJ onto the screen SC.

The projection device 110 has a light source device 111, a light modulation device 112, and a projection system 113. The driver 120 has a light source driver 121 and a light modulation device driver 122.

The screen SC is equivalent to an example of a “projection surface”.

The projection device 110 is equivalent to an example of an “optical device”.

The light source device 111 has a light source. The light source is, for example, a solid-state light source such as an LED (light-emitting diode) or a laser light source.

In this embodiment, the case where the light source of the light source device 111 is a solid-state light source is described. However, this is not limiting. The light source of the light source device 111 may be a lamp light source such as a halogen lamp, a xenon lamp, or an ultra-high-pressure mercury lamp.

The light source device 111 may also have a reflector and an auxiliary reflector that guide the light emitted from the light source to the light modulation device 112. The light source device 111 may also have a lens group and a polarizer to enhance optical characteristics of projection light, or a dimmer or the like to reduce the amount of light of the light emitted from the light source, in the path to the light modulation device 112.

The light source driver 121 is coupled to an internal bus 107 and turns on and off the light source of the light source device 111 and thus controls the output from the light source in response to an instruction from a first controller 150 similarly coupled to the internal bus 107.

The light modulation device 112 has, for example, three liquid crystal panels 115 corresponding to the three primary colors of R, G, and B. R represents the color of red. G represents the color of green. B represents the color of blue. That is, the light modulation device 112 has a liquid crystal panel 115 corresponding to red-color light, a liquid crystal panel 115 corresponding to green-color light, and a liquid crystal panel 115 corresponding to blue-color light.

The light emitted from the light source device 111 is separated into color lights of the three colors of RGB, which then become incident on the corresponding liquid crystal panels 115, respectively. Each of the three liquid crystal panels 115 is a transmission-type liquid crystal panel and modulates the light transmitted therethrough and thus generates the image light PL. The image light PL transmitted through and thus modulated by the respective liquid crystal panels 115 are combined together by a light combining system such as a cross dichroic prism, and the combined light is emitted to the projection system 113.

The range that can be displayed on the liquid crystal panel 115 corresponds to the maximum range within which the projection image PJ can be projected, shown by the guide image PG.

In this embodiment, the case where the light modulation device 112 has the transmission-type liquid crystal panel 115 as a light modulation element is described. However, this is not limiting. The light modulation element may be a reflection-type liquid crystal panel or a digital micromirror device.

The light modulation device 112 is driven by the light modulation device driver 122. The light modulation device driver 122 is coupled to an image processor 145.

Image data corresponding to the primary colors of R, G, B are inputted to the light modulation device driver 122 from the image processor 145. The light modulation device driver 122 converts the inputted image data to a data signal suitable for the operation of the liquid crystal panel 115. The light modulation device driver 122 applies a voltage to each pixel in the liquid crystal panel 115, based on the converted data signal, and thus draws an image on each liquid crystal panel 115.

The projection system 113 has a projection lens that causes the incident image light PL to form an image on the screen SC, a mirror, and the like. The projection system 113 also has a zoom mechanism that enlarges or reduces the image projected on the screen SC, a focus adjustment mechanism that adjusts the focus, and a lens shift mechanism that adjusts the direction of projection of the image light PL, and the like.

The projector 100 also has an operator 131, a remote control light receiver 133, an input interface 135, a storage 137, a first communication interface 141, a frame memory 143, the image processor 145, and the first controller 150. The input interface 135, the storage 137, the first communication interface 141, the image processor 145, and the first controller 150 are coupled in such a way as to be able to communicate data with each other via the internal bus 107.

The operator 131 has various buttons and switches provided on the surface of the casing of the projector 100. The operator 131 generates an operation signal corresponding to an operation on these buttons and switches and outputs the operation signal to the input interface 135. The operator 131 has four buttons that designate directions. The four buttons are made up of an up button BU, a down button BD, a left button BL, and a right button BR. The input interface 135 has a circuit that outputs the operation signal inputted from the operator 131 to the first controller 150.

The remote control light receiver 133 receives an infrared signal transmitted from a remote controller 5, decodes the received infrared signal, and thus generates an operation signal. The remote control light receiver 133 outputs the generated operation signal to the input interface 135. The input interface 135 has a circuit that outputs the operation signal inputted from the remote control light receiver 133 to the first controller 150.

The storage 137 is, for example, a storage device using a magnetic recording device such as an HDD (hard disk drive) or a semiconductor memory device such as a flash memory or an SSD (solid-state drive). The storage 137 stores a program to be executed by the first controller 150, data processed by the first controller 150, and image data or the like.

The first communication interface 141 is a communication interface that executes communication with the image supply device 200 in conformity with the Ethernet (registered trademark) standard. The first communication interface 141 has a connector to couple an Ethernet (registered trademark) cable, and an interface circuit that processes a signal transmitted through the connector. The first communication interface 141 is an interface board having the connector and the interface circuit and is coupled to a main board where a first processor 150A or the like of the first controller 150 is provided. Alternatively, the connector and the interface circuit forming the first communication interface 141 are provided at the main board of the first controller 150. The first communication interface 141 receives image data or the like from the image supply device 200.

The first controller 150 has a first memory 150B and the first processor 150A. The first memory 150B is a storage device that stores the program to be executed by the first controller 150 and data in a non-volatile manner. The first memory 150B is formed of a magnetic storage device, a semiconductor memory device such as a flash ROM (read-only memory), or another type of non-volatile storage device. The first memory 150B may include a RAM (random-access memory) forming a work area of the first processor 150A. The first memory 150B stores data to be processed by the first controller 150, and a first control program PGM1 to be executed by the first processor 150A, or the like.

The first processor 150A may be formed of a single processor. Also, a configuration where a plurality of processors function as the first processor 150A may be employed. The first processor 150A executes a first control program PGM1 and thus controls each part of the projector 100. For example, the first processor 150A outputs an instruction to execute image processing corresponding to an operation accepted by the operator 131 and the remote controller 5, and a parameter used for the image processing, to the image processor 145. The parameter includes, for example, a geometric correction parameter to correct a geometric distortion of the image projected on the screen SC, or the like. The first processor 150A controls the light source driver 121 to control the turning on and off of the light source device 111 and also adjusts the output, that is, the amount of light, of the light source device 111.

The first processor 150A is equivalent to an example of a “processor”.

The first processor 150A may be formed of a SoC (system on a chip) integrated with a part or the entirety of the first memory 150B and another circuit. The first processor 150A may also be formed of a combination of a CPU (central processing unit) that executes a program and a DSP (digital signal processor) that executes predetermined computational processing. Also, a configuration where all the functions of the first processor 150A are provided in hardware or a configuration using a programmable device may be employed.

The image processor 145 and the frame memory 143 can be formed of, for example, an integrated circuit. The integrated circuit an includes LSI (large-scale integration), an ASIC (application-specific integrated circuit), and a PLD (programmable logic device). The PLD includes, for example, an FPGA (field-programmable gate array). A part of the configuration of the integrated circuit may include an analog circuit. Also, a combination of a processor and an integrated circuit may be employed. The combination of the processor and the integrated circuit is referred to as a microcontroller (MCU), a SoC (system on a chip), a system LSI, a chip set, or the like.

The image processor 145 loads the image data inputted from the first communication interface 141 into the frame memory 143. The frame memory 143 has a plurality of banks. Each bank has a storage capacity in which image data of one frame can be written. The frame memory 143 is formed of, for example, an SDRAM (synchronous dynamic random-access memory).

The image processor 145 performs, for example, image processing such as resolution conversion, resizing, correction of a distortion, shape correction, digital zoom, or adjustment of the color tone or luminance of an image, on the image data loaded in the frame memory 143.

The image processor 145 also generates vertical synchronizing signal with the input frame frequency thereof converted into a drawing frequency. The generated vertical synchronizing signal is referred to as an output synchronizing signal. The image processor 145 outputs the generated output synchronizing signal to the light modulation device driver 122.

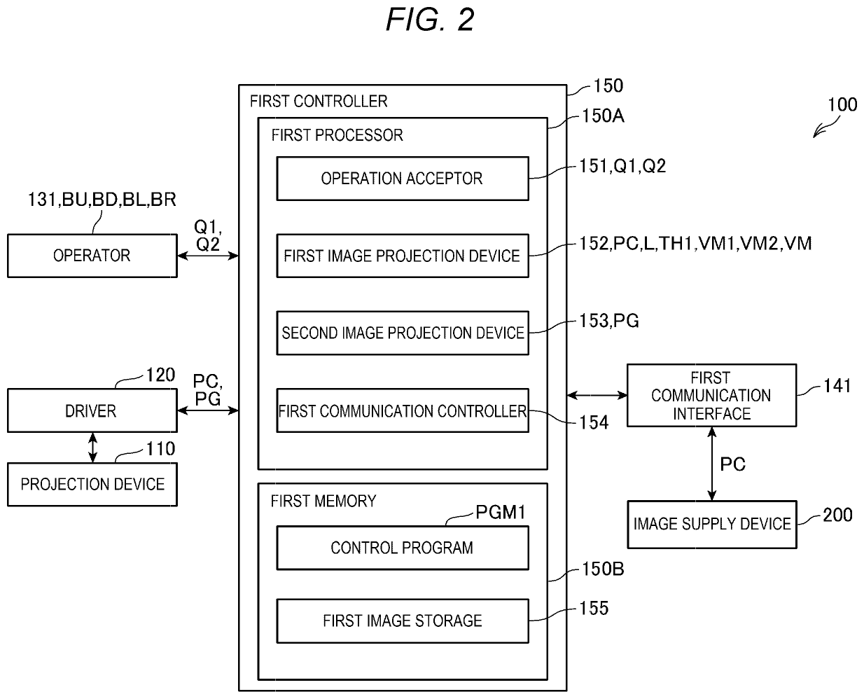

The configuration of the first controller 150 of the projector 100 will now be described with reference to FIG. 2. FIG. 2 shows an example of the configuration of the first controller 150 of the projector 100. The first controller 150 controls operations of the projector 100.

As shown in FIG. 2, the first controller 150 has an operation acceptor 151, a first image projection device 152, a second image projection device 153, a first communication controller 154, and a first image storage 155. Specifically, the first processor 150A of the first controller 150 executes the first control program PGM1 stored in the first memory 150B and thus functions as the operation acceptor 151, the first image projection device 152, the second image projection device 153, and the first communication controller 154. Also, the first processor 150A of the first controller 150 executes the first control program PGM1 stored in the first memory 150B and thus causes the first memory 150B to function as the first image storage 155.

The first control program PGM1 is equivalent to an example of a “control program”.

The first image storage 155 stores the correction target image PC and the guide image PG. The correction target image PC is accepted from the image supply device 200 by the first image projection device 152 and is stored in the first image storage 155 by the first image projection device 152. The guide image PG is generated by the second image projection device 153 and is stored in the first image storage 155 by the second image projection device 153.

The first image projection device 152 accepts the correction target image PC from the image supply device 200 and stores the correction target image PC in the first image storage 155. The first image projection device 152 also projects the correction target image PC onto the screen SC.

When a first operation Q1 of moving the position of the correction target image PC on the screen SC is accepted, the first image projection device 152 moves the correction target image PC in a direction corresponding to the first operation Q1. In this embodiment, the first operation Q1 is, for example, an operation of pressing one of the up button BU, the down button BD, the left button BL, and the right button BR arranged at the operator 131.

In this embodiment, the case where the first operation Q1 is an operation to the operator 131 is described. However, this is not limiting. The first operation Q1 may be, for example, an operation to the remote controller 5.

When the first operation Q1 of moving the position of the correction target image PC on the screen SC is accepted, the first image projection device 152 detects a distance L between the correction target image PC and a line image PGA of the guide image PG. The first image projection device 152 detects, for example, the distance between the correction target image PC and the line image PGA of the guide image PG displayed on the liquid crystal panel 115, as the distance L. The distance L is the distance between the correction target image PC and the line image PGA of the guide image PG in the direction of movement of the correction target image PC. The distance L is expressed, for example, by the number of pixels.

When the distance L is equal to or shorter than a first threshold TH1, the first image projection device 152 reduces a moving speed VM of the correction target image PC. For example, when the distance L is equal to or shorter than the first threshold TH1, the first image projection device 152 reduces the moving speed VM of the correction target image PC from a first speed VM1 to a second speed VM2 that is lower than the first speed VM1. The first speed VM1 is, for example, 20 pixels per second. The second speed VM2 is, for example, 10 pixels per second.

In this embodiment, the case where the first image projection device 152, for example, reduces the moving speed VM of the correction target image PC stepwise when the distance L has reached the first threshold TH1 is described. However, this is not limiting. The first image projection device 152 may, for example, reduce the moving speed VM in a ramp-like manner according to the distance L when the distance L is equal to or shorter than the first threshold TH1. For example, the first image projection device 152 may set the moving speed VM in proportion to the distance L when the distance L is equal to or shorter than the first threshold TH1.

The first image projection device 152 stops moving the correction target image PC when the distance L has reached zero, that is, when at least one of the four corners of the correction target image PC has reached the position of the line image PGA.

The processing by the first image projection device 152 will be described further with reference to FIGS. 3 to 5.

The second image projection device 153 generates the guide image PG showing the maximum range within which the correction target image PC can be projected. The guide image PG includes the line image PGA. The line image PGA surrounds the correction target image PC and shows the outer circumference of the guide image PG. In other words, the line image PGA shows the outer circumference of the maximum range within which the correction target image PC can be projected. The line image PGA is, for example, a white line. The line image PGA also shows the outer circumference of the range that can be displayed on the liquid crystal panel 115, as described with reference to FIG. 1.

When a second operation Q2 of changing the color of the line image PGA is accepted from the user, the second image projection device 153 changes the color of the line image PGA in response to the second operation Q2.

For example, when the second operation Q2 of changing the color of the line image PGA from white to yellow is accepted, the second image projection device 153 changes the color of the line image PGA from white to yellow. Since the second image projection device 153 thus changes the color of the line image PGA in response to the second operation Q2, the user can display the line image PGA in a desired color.

In this embodiment, the case where the second image projection device 153 changes the color of the line image PGA in response to the second operation Q2 by the user is described. However, this is not limiting. The second image projection device 153 may change the display form of the line image PGA in response to an operation by the user. The display form of the line image PGA includes the color, the line type, and the boldness of the line image PGA.

When the distance L detected by the first image projection device 152 is equal to or shorter than a second threshold TH2, the second image projection device 153 changes the display form of the line image PGA. The second threshold TH2 may be greater than the first threshold TH1, smaller than the first threshold TH1, or the same value as the first threshold TH1. The display form includes the boldness, the line type, and the color of the line of the line image PGA.

In this embodiment, for example, the case where the second threshold TH2 is the same value as the first threshold TH1 is described. The first threshold TH1 and the second threshold TH2 are, for example, 50 pixels.

Also, in this embodiment, when the distance L detected by the first image projection device 152 has reached zero, that is, when at least one of the four corners of the correction target image PC has reached the position of the line image PGA, the second image projection device 153 changes the display form of the line image PGA.

In this embodiment, for example, the second image projection device 153 changes the boldness of the line of the line image PGA when the distance L detected by the first image projection device 152 is equal to or shorter than the second threshold TH2, and the second image projection device 153 changes the color of the line of the line image PGA when the distance L has reached zero.

The processing by the second image projection device 153 will be described further with reference to FIGS. 3 to 5.

The first communication controller 154 receives the correction target image PC from the image supply device 200 via the first communication interface 141.

The processing by the first image projection device 152 and the second image projection device 153 will now be described with reference to FIGS. 3 to 5. First, the correction target image PC and the guide image PG displayed on the screen SC in an initial state will be described with reference to FIG. 3.

FIG. 3 shows an example of the configuration of the image projection system 1 in the initial state. As shown in FIG. 3, the image projection system 1 has the projector 100 and the image supply device 200. The image supply device 200 transmits the correction target image PC to the projector 100. The projector 100 projects the correction target image PC and the guide image PG onto the screen SC.

In this embodiment, the case where the so-called keystone correction, from among geometric corrections, is complete in the initial state is described. That is, a correction target image PC1 displayed on the screen SC is rectangular in the initial state, as shown in FIG. 3. The correction target image PC1 is displayed at the center of the screen SC. The correction target image PC1 is the correction target image PC in the initial state.

The guide image PG is formed of the line image PGA, as shown in FIG. 3. The line image PGA surrounds the correction target image PC and shows the outer circumference of the guide image PG. The line image PGA in the initial state is referred to as a line image PG1. In FIG. 3, the correction target image PC is displayed in a rectangular shape. The line image PG1 is displayed substantially in an inverted trapezoidal shape. Also, the line image PG1 is displayed, for example, in the color of white.

FIG. 3 shows an example of the distance L. The distance L is the distance between the correction target image PC and the line image PG1. The distance L is, for example, the shortest distance of the distances between one of the four vertices VX1, VX2, VX3, and VX4 of the correction target image PC1, and one of the four sides SD1, SD2, SD3, and SD4 forming the line image PG1. FIG. 3 shows the case where the distance L is the distance between the vertex VX4 and the side SD4. The distance between which of the four vertices of the correction target image PC1 and which of the four sides forming the line image PG1 is employed as the distance L may be suitably changed according to a direction of movement D of the correction target image PC1.

For example, in FIG. 3, the correction target image PC1 moves in the direction of movement D. Therefore, the distance L is the distance between the vertex VX4, which is at the foremost point in the direction of movement D, of the four vertices VX1, VX2, VX3, and VX4, and the side SD4 intersecting an imaginary line passing through the vertex VX4 along the direction of movement D, of the four sides SD1, SD2, SD3, and SD4.

The four vertices VX1, VX2, VX3, and VX4 are equivalent to an example of parts forming an “outer circumference of the correction target image PC”. The “outer circumference of the correction target image PC” may be a line connecting the four vertices VX1, VX2, VX3, and VX4 together, that is, an outline C of the correction target image PC. In other words, the outer circumference of the correction target image PC is the outline C passing through the four vertices VX1, VX2, VX3, and VX4. The outline C may be not displayed or may be displayed as an image similarly to the line image PG1.

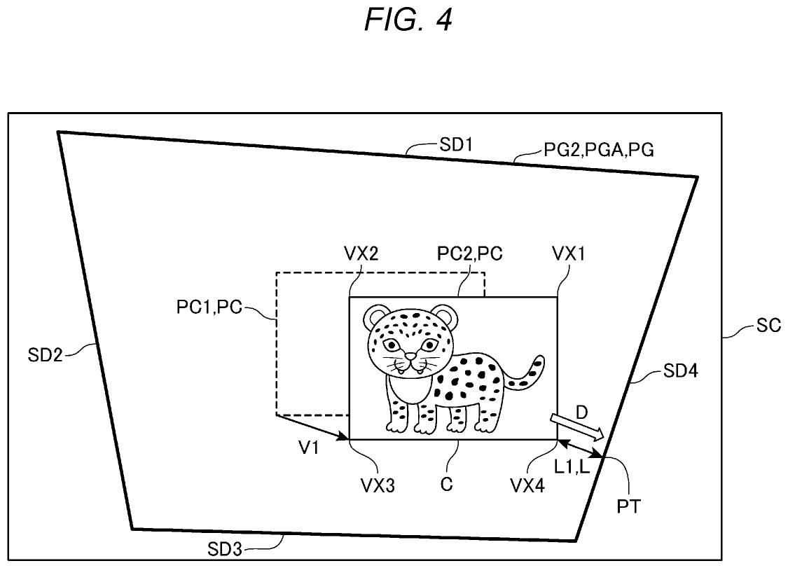

FIG. 4 shows an example of the correction target image PC and the line image PGA in a first state. In the first state, the correction target image PC is moved in a right direction, as compared with the initial state.

In other words, FIG. 4 explains the case where the first image projection device 152 accepts a press on the right button BR as the first operation Q1 and moves the correction target image PC in the right direction. A vector V1 represents the direction of movement of the correction target image PC and the distance moved.

In this embodiment, the first operation Q1 is, for example, an operation of pressing one of the up button BU, the down button BD, the left button BL, and the right button BR arranged at the operator 131. When the first image projection device 152 has accepted a press on the up button BU, the first image projection device 152 moves the correction target image PC in an up direction. When the first image projection device 152 has accepted a press on the down button BD, the first image projection device 152 moves the correction target image PC in a down direction. When the first image projection device 152 has accepted a press on the left button BL, the first image projection device 152 moves the correction target image PC in a left direction. When the first image projection device 152 has accepted a press on the right button BR, the first image projection device 152 moves the correction target image PC in the right direction at the first speed VM1.

The up direction, the down direction, the left direction, and the right direction, which are the directions of movement of the correction target image PC, will now be described. The up direction and the down direction correspond to the direction of the short sides of the display area on the liquid crystal panel 115. That is, the up direction and the down direction are directions parallel to the direction of the short sides of the display area on the liquid crystal panel 115. The left direction and the right direction correspond to the direction of the long sides of the display area on the liquid crystal panel 115. That is, the left direction and the right direction are directions parallel to the direction of the long sides of the display area on the liquid crystal panel 115.

In this way, the display area on the liquid crystal panel 115 prescribes the up direction, the down direction, the left direction, and the right direction, which are the directions of movement of the correction target image PC. Thus, the up direction, the down direction, the left direction, and the right direction, which are the directions of movement of the correction target image PC, differ from the up direction, the down direction, the left direction, and the right direction on the screen SC.

In FIG. 4, the position of the correction target image PC1 in the initial state is indicated by a dashed line. The correction target image PC after the movement is referred to as a correction target image PC2. A distance L1 is the distance between the correction target image PC2 and the line image PGA. The distance L1 is the distance between the vertex VX4 of the correction target image PC2 and the side SD4 of the line image PGA. The distance L1 is, for example, shorter than the first threshold TH1 and the second threshold TH2.

Since the distance L is equal to or shorter than the first threshold TH1, the first image projection device 152 reduces the moving speed VM of the correction target image PC from the first speed VM1 to the second speed VM2, which is lower than the first speed VM1.

Also, since the distance L is equal to or shorter than the second threshold TH2, the second image projection device 153 changes the display form of the line image PGA. For example, as indicated by a line image PG2, the second image projection device 153 changes the line to a bolder line than the line of the line image PG1, which is the line image PGA in the initial state. The line image PG2 is the line image PGA in the first state.

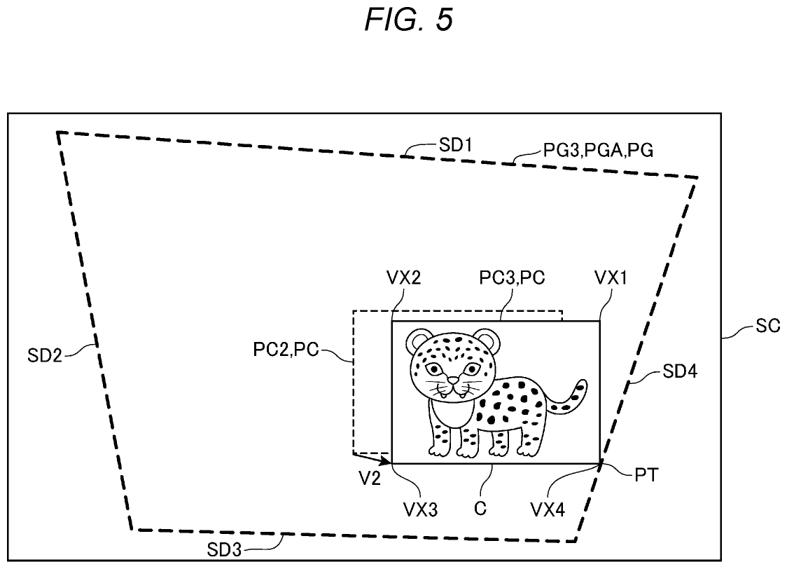

FIG. 5 shows an example of the correction target image PC and the line image PGA in a second state. In the second state, the correction target image PC is moved further in the right direction, as compared with the first state.

In other words, FIG. 5 explains the case where the first image projection device 152 accepts a press on the right button BR as the first operation Q1 and moves the correction target image PC further in the right direction. A vector V2 represents the direction of movement of the correction target image PC and the distance moved.

In FIG. 5, the position of the correction target image PC2 in the first state is indicated by a dashed line. The correction target image PC in the second state is referred to as a correction target image PC3. In the second state, the vertex VX4 of the correction target image PC3 is located on the side SD4 of the line image PGA. In other words, the distance L is zero in the second state.

Since the distance L is zero, the first image projection device 152 stops moving the correction target image PC.

Also, since the distance L is zero, the second image projection device 153 changes the display form of the line image PGA. For example, as indicated by a line image PG3, the second image projection device 153 changes the color of the line in such a way that the line image PG3, which is the line image PGA in the second state, is a red line, for example, whereas the line image PG2, which is the line image PGA in the first state, is a white line. In FIG. 5, a dashed line indicates that the line image PG3 in the second state is in red.

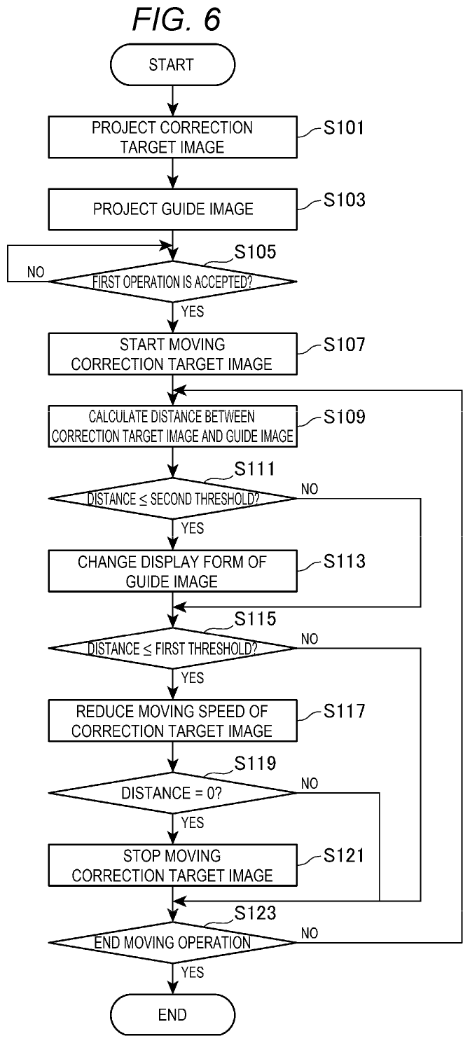

The processing by the first controller 150 of the projector 100 will now be described with reference to FIG. 6. FIG. 6 is a flowchart showing an example of the processing by the first controller 150 of the projector 100.

As shown in FIG. 6, first, in step S101, the first image projection device 152 projects correction target image PC onto the screen SC.

Next, in step S103, the second image projection device 153 generates the guide image PG and projects the generated guide image PG onto the screen SC.

Next, in step S105, the first image projection device 152 determines whether the first operation Q1 is accepted or not. The first operation Q1 is an operation of moving the position of the correction target image PC on the screen SC.

When the first image projection device 152 has determined that the first operation Q1 is not accepted (NO in step S105), the processing enters a waiting state. When the first image projection device 152 has determined that the first operation Q1 is accepted (YES in step S105), the processing proceeds to step S107.

In step S107, the first image projection device 152 starts moving the position of the correction target image PC.

Next, in step S109, the first image projection device 152 detects the distance L between the correction target image PC and the line image PGA of the guide image PG.

Next, in step S111, the second image projection device 153 determines whether the distance L is equal to or shorter than the second threshold TH2 or not.

When the second image projection device 153 has determined that the distance L is not equal to or shorter than the second threshold TH2 (NO in step S111), the processing proceeds to step S115. When the second image projection device 153 has determined that the distance L is equal to or shorter than the second threshold TH2 (YES in step S111), the processing proceeds to step S113.

In step S113, the second image projection device 153 changes the display form of the guide image PG, that is, the line image PGA. For example, the second image projection device 153 increases the boldness of the line of the line image PGA.

Next, in step S115, the first image projection device 152 determines whether the distance L is equal to or shorter than the first threshold TH1 or not.

When the first image projection device 152 has determined that the distance L is not equal to or shorter than the first threshold TH1 (NO in step S115), the processing proceeds to step S123. When the first image projection device 152 has determined that the distance L is equal to or shorter than the first threshold TH1 (YES in step S115), the processing proceeds to step S117.

In step S117, the first image projection device 152 reduces the moving speed VM of the correction target image PC from the first speed VM1 to the second speed VM2.

Next, in step S119, the first image projection device 152 determines whether the distance L is zero or not.

When the first image projection device 152 has determined that the distance L is not zero (NO in step S119), the processing proceeds to step S123. When the first image projection device 152 has determined that the distance L is zero (YES in step S119), the processing proceeds to step S121.

In step S121, the first image projection device 152 stops moving the correction target image PC.

Next, in step S123, the first controller 150 determines whether an end operation is accepted or not. The end operation is an operation carried out to the operator 131 by the user when ending the movement of the correction target image PC. The end operation is, for example, an operation on a specific key arranged at the operator 131.

When the first controller 150 has determined that the end operation is not accepted (NO in step S123), the processing returns to step S109. When the first controller 150 has determined that the end operation is accepted (YES in step S123), the processing subsequently ends.

Step S101 is equivalent to an example of “projecting the correction target image onto the projection surface”. Step S103 is equivalent to an example of “projecting the guide image onto the projection surface”. Step S113 is equivalent to an example of “changing the display form of the line image”. Step S117 is equivalent to an example of “changing the moving speed of the correction target image”. Step S121 is equivalent to an example of “stopping the movement of the position of the correction target image on the projection surface”.

As described with reference to FIG. 6, the first image projection device 152 stops moving the correction target image PC when the distance L has reached zero, that is, when at least a part of the outer circumference of the correction target image PC has reached the position of the line image PGA. For example, the first image projection device 152 stops moving the correction target image PC when at least one of the four corners of the correction target image PC has reached the position of the line image PGA.

When the first image projection device 152 has accepted a first operation Q1′ from the user that causes the correction target image PC to move beyond the line image PGA after stopping the movement of the correction target image PC, the first image projection device 152 disables this first operation Q1′ and does not move the correction target image PC.

Thus, the user can easily visually recognize that the correction target image PC cannot be moved to outside the line image PGA. Also, the first image projection device 152 reduces the moving speed VM of the correction target image PC when the distance L is equal to or shorter than the first threshold TH1. The first image projection device 152 stops moving the correction target image PC when the distance L has reached zero. Therefore, the correction target image PC can be displayed in a natural manner from the movement to the stop. Also, the second image projection device 153 changes the display form of the line image PGA when the distance L is equal to or shorter than the second threshold TH2. Therefore, the user can easily visually recognize that the correction target image PC has come closer to the line image PGA.

### PRESENT EMBODIMENT AND ADVANTAGEOUS EFFECTS THEREOF

As described above with reference to FIGS. 1 to 6, the projection method for the projector 100 according to this embodiment includes: projecting, onto the screen SC, the correction target image PC that is a target of shape correction; and projecting, onto the screen SC, the guide image PG showing the maximum range within which the correction target image PC can be projected, when the correction target image PC is projected on the screen SC.

That is, the correction target image PC that is a target of shape correction and the guide image PG showing the maximum range within which the correction target image PC can be projected are projected on the screen SC.

Since the guide image PG shows the maximum range within which the correction target image PC can be projected, the user can visually recognize the range within which the correction target image PC can be moved, based on the guide image PG. The convenience for the user can thus be improved.

The projection method for the projector 100 further includes: accepting the second operation Q2 of changing the color of the guide image PG from the user; and changing the color of the guide image PG in response to the second operation Q2.

Thus, the user can change the color of the guide image PG to a desired color, for example, a color that the user can easily visually recognize, based on the color of the screen SC. The convenience for the user can thus be improved.

In the projection method for the projector 100, the guide image PG includes the line image PGA surrounding the correction target image PC and showing the outer circumference of the guide image PG.

Since the guide image PG includes the line image PGA surrounding the correction target image PC and showing the outer circumference of the guide image PG, the user can visually recognize the range within which the correction target image PC can be moved, based on the line image PGA. The convenience for the user can thus be improved.

The projection method for the projector 100 further includes: stopping the movement of the position of the correction target image PC on the screen SC, when the first operation Q1 of moving the position of the correction target image PC on the screen SC is accepted and at least a part of the outer circumference of the correction target image PC, for example, at least one of the vertices VX1, VX2, VX3, and VX4 of the correction target image PC, has reached the position of the line image PGA.

Since the movement of the position of the correction target image PC on the screen SC is stopped when at least a part of the outer circumference of the correction target image PC, for example, at least one of the vertices VX1 to VX4 of the correction target image PC, has reached the position of the line image PGA, the user can visually recognize that the correction target image PC cannot be moved. The convenience for the user can thus be improved.

The projection method for the projector 100 further includes: changing the moving speed of the correction target image PC according to the distance L between the outer circumference of the correction target image PC and the line image PGA when the first operation of moving the position of the correction target image PC on the screen SC is accepted.

Since the moving speed of the correction target image PC is changed according to the distance L, the user can visually recognize or grasp that the correction target image PC has come closer to a position where the correction target image PC cannot be moved, based on the change in the moving speed. The convenience for the user can thus be improved.

The projection method for the projector 100 further includes: changing the display form of the line image PGA according to the distance L between the correction target image PC and the line image PGA when the first operation Q1 of moving the position of the correction target image PC on the screen SC is accepted.

Since the display form of the line image PGA is changed according to the distance L, the user can visually recognize that the correction target image PC has come closer to a position where the correction target image PC cannot be moved. The convenience for the user can thus be improved.

The projector 100 according to this embodiment includes the projection device 110 and the first processor 150A. The first processor 150A executes: projecting, onto the screen SC, the correction target image PC that is a target of shape correction; and projecting, onto the screen SC, the guide image PG showing the maximum range within which the correction target image PC can be projected, when the correction target image PC is projected on the screen SC.

Thus, the projector 100 according to this embodiment can achieve effects similar to those of the projection method for the projector 100 according to this embodiment.

The first control program PGM1 according to this embodiment causes the first processor 150A execute: projecting, onto the screen SC, the correction target image PC that is a target of shape correction; and projecting, onto the screen SC, the guide image PG showing the maximum range within which the correction target image PC can be projected, when the correction target image PC is projected on the screen SC.

Thus, the first control program PGM1 according to this embodiment can achieve effects similar to those of the projection method for the projector 100 according to this embodiment.

### Other Embodiments

The foregoing embodiment is a preferred embodiment. However, the present disclosure is not limited to the foregoing embodiment and can be implemented with various modifications without departing from the spirit and scope of the present disclosure.

In the embodiment, the case where the so-called keystone correction, from among geometric corrections, is complete in the initial state is described. However, this is not limiting. The initial state may take place before the keystone correction, for example, or during the keystone correction, for example. That is, the guide image PG may be displayed before the keystone correction or during the keystone correction. When the guide image PG is displayed before the keystone correction, the user can roughly grasp, in advance, how much the size and position of the guide image PG can be changed. When the guide image PG is displayed during the keystone correction, the user can perform the keystone correction, referring to the guide image PG.

In the embodiment, the case where the second threshold TH2 is the same value as the first threshold TH1 is described with reference to FIGS. 3 to 5. However, this is not limiting. The second threshold TH2 may be greater or smaller than the first threshold TH1.

In the embodiment, the case where the first image projection device 152 stops moving the correction target image PC when at least one of the four corners of the correction target image PC has reached the position of the line image PGA is described. However, this is not limiting. The first image projection device 152 may stop moving the correction target image PC when at least a part of the outer circumference of the correction target image PC, that is, at least a part of the outline C, has reached the position of the line image PGA.

In the embodiment, the case where the guide image PG is the line image PGA is described. However, this is not limiting. The guide image PG may be formed of, for example, the line image PGA and a grid image. The grid image is, for example, a mesh-like image that is displayed throughout the inside of the line image PGA and that has a plurality of lines crossing each other. As the grid image is displayed, when the first image projection device 152 accepts the first operation Q1 and moves the correction target image PC in the direction corresponding to the first operation Q1, the user can easily visually recognize the direction of movement and the moving speed of the correction target image PC. The guide image PG may be formed of the grid image only. The second image projection device 153 may change the display form of the grid image as the guide image PG in response to an operation by the user. That is, the second image projection device 153 changes the display form of the guide image PG in response to an operation by the user.

In the embodiment, the case where the first image projection device 152 reduces the moving speed VM of the correction target image PC when the distance L is equal to or shorter than the first threshold TH1 is described. However, this is not limiting. The first image projection device 152 may increase the moving speed VM of the correction target image PC when the distance L is equal to or shorter than the first threshold TH1. This is because, when the moving speed VM of the correction target image PC is changed according to the distance L, the user can visually recognize or grasp that the correction target image PC has come closer to a position where the correction target image PC cannot be moved, based on the change in the moving speed.

The functional elements shown in FIG. 2 represent a functional configuration and are not particularly limited to any specific form of installation. That is, pieces of hardware corresponding individually to the functional elements need not necessarily be installed. A configuration where one processor executes a program and thus implements functions of a plurality of functional elements may be employed. Also, a part of the functions implemented by software in the embodiment may be implemented by hardware, and a part of the functions implemented by hardware may be implemented by software. The specific detailed configuration of each part of the projector 100 can be arbitrarily changed without departing from the spirit and scope of the present disclosure.

The processing steps in the flowchart shown in FIG. 6 are provided by dividing the processing according to the main content of the processing in order to facilitate the understanding of the processing by the first controller 150 of the projector 100. The way the processing is divided into processing steps and the names of the processing steps shown in the flowchart of FIG. 6 do not limit the present disclosure. The processing may also be divided into more steps according to the content of the processing. The processing may also be divided in such a way that one processing step includes more processing. The order of the processing in the foregoing flowchart is not limited to the illustrated example.

The projection method for the projector 100 can be implemented by causing the first processor 150A provided in the projector 100 to execute the first control program PGM1 corresponding to the projection method for the projector 100. The first control program PGM1 can be recorded in advance, for example, in a recording medium in a computer-readable manner.

As the recoding medium, a magnetic or optical recording medium or a semiconductor memory device can be used. Specifically, a portable recording medium such as a flexible disk, an HDD, a CD-ROM (compact disc read-only memory), a DVD, a Blu-ray (registered trademark) disc, a magneto-optical disk, a flash memory, or a card-type recording medium, or a fixed recording medium may be employed. The recording medium may also be a non-volatile storage device such as a RAM, a ROM, or an HDD that is an internal storage device provided in the image supply device 200.

The first control program PGM1 can also be stored in a server device or the like in advance and can be downloaded from the server device to the projector 100 to implement the projection method for the projector 100.

### SUPPLEMENTARY NOTES

A summary of the present disclosure will be given below in the form of supplementary notes.

### Supplementary Note 1

A projection method for a projector includes: projecting, onto a projection surface, a correction target image that is a target of shape correction; and projecting, onto the projection surface, a guide image showing a maximum range within which the correction target image can be projected, when the correction target image is projected on the projection surface.

Since the correction target image and the guide image showing the maximum range within which the correction target image can be projected are projected on the projection surface, the user can visually recognize the range within which the correction target image can be moved, based on the guide image. The convenience for the user can thus be improved.

### Supplementary Note 2

The projection method for the projector according to Supplementary Note 1 further includes: accepting an operation of changing a color of the guide image from a user; and changing the color of the guide image in response to the operation.

Thus, the user can change the color of the guide image to a desired color, for example, a color that the user can easily visually recognize, based on the color of the screen. The convenience for the user can thus be improved.

### Supplementary Note 3

In the projection method for the projector according to Supplementary Note 1 or 2, the guide image includes a line image surrounding the correction target image and showing an outer circumference of the guide image.

Since the guide image includes the line image surrounding the correction target image and showing the outer circumference of the guide image, the user can visually recognize the range within which the correction target image can be moved, based on the line image. The convenience for the user can thus be improved.

### Supplementary Note 4

The projection method for the projector according to Supplementary Note 3 further includes: stopping a movement of a position of the correction target image on the projection surface, when an operation of moving the position of the correction target image on the projection surface is accepted and at least a part of an outer circumference of the correction target image reaches a position of the line image.

Since the movement of the position of the correction target image on the screen is stopped when at least a part of the outer circumference of the correction target image has reached the position of the line image, the user can visually recognize that the correction target image cannot be moved. The convenience for the user can thus be improved.

### Supplementary Note 5

The projection method for the projector according to Supplementary Note 3 or 4 further includes: changing a moving speed of the correction target image according to a distance between the correction target image and the line image when an operation of moving a position of the correction target image on the projection surface is accepted.

Since the moving speed of the correction target image is changed according to the distance between the correction target image and the line image, the user can visually recognize that the correction target image has come closer to a position where the correction target image cannot be moved. The convenience for the user can thus be improved.

### Supplementary Note 6

The projection method for the projector according to one of Supplementary Notes 3 to 5 further includes: changing a display form of the line image according to a distance between the correction target image and the line image when an operation of moving a position of the correction target image on the projection surface is accepted.

Since the display form of the line image is changed according to the distance between the correction target image and the line image, the user can visually recognize that the correction target image has come closer to a position where the correction target image cannot be moved. The convenience for the user can thus be improved.

### Supplementary Note 7

A projector includes an optical device and a processor. The processor executes: projecting, onto a projection surface, a correction target image that is a target of shape correction; and projecting, onto the projection surface, a guide image showing a maximum range within which the correction target image can be projected, when the correction target image is projected on the projection surface.

Thus, the projector according to Supplementary Note 7 can achieve effects similar to those of the projection method for the projector according to Supplementary Note 1.

### Supplementary Note 8

A non-transitory computer-readable storage medium storing a control program for a projector is provided. The control program causes a processor to execute: projecting, onto a projection surface, a correction target image that is a target of shape correction; and projecting, onto the projection surface, a guide image showing a maximum range within which the correction target image can be projected, when the correction target image is projected on the projection surface.

Thus, the control program for the projector according to Supplementary Note 8 can achieve effects similar to those of the projection method for the projector according to Supplementary Note 1.

What is claimed is:

1. A projection method for a projector comprising:
projecting, onto a projection surface, a correction target image that is a target of shape correction; and
projecting, onto the projection surface, a guide image showing a maximum range within which the correction target image can be projected, when the correction target image is projected on the projection surface.

2. The projection method for the projector according to claim 1, further comprising:
accepting an operation of changing a color of the guide image from a user; and
changing the color of the guide image in response to the operation.

3. The projection method for the projector according to claim 1, wherein
the guide image includes a line image surrounding the correction target image and showing an outer circumference of the guide image.

4. The projection method for the projector according to claim 3, further comprising:
stopping a movement of a position of the correction target image on the projection surface, when an operation of moving the position of the correction target image on the projection surface is accepted and at least a part of an outer circumference of the correction target image reaches a position of the line image.

5. The projection method for the projector according to claim 3, further comprising:
changing a moving speed of the correction target image according to a distance between an outer circumference of the correction target image and the line image when an operation of moving a position of the correction target image on the projection surface is accepted.

6. The projection method for the projector according to claim 3, wherein
the correction target image is a rectangular image,
the projection method further comprising:
changing a display form of the line image according to a distance between the correction target image and the line image when an operation of moving a position of the correction target image on the projection surface is accepted.

7. A projector comprising:
an optical device; and
a processor,
the processor executing:
projecting, onto a projection surface, a correction target image that is a target of shape correction; and
projecting, onto the projection surface, a guide image showing a maximum range within which the correction target image can be projected, when the correction target image is projected on the projection surface.

8. A non-transitory computer-readable storage medium storing a control program for a projector, the control program causing a processor to execute:
projecting, onto a projection surface, a correction target image that is a target of shape correction; and
projecting, onto the projection surface, a guide image showing a maximum range within which the correction target image can be projected, when the correction target image is projected on the projection surface.
